(19) United States
(12) Patent Application Publication
(10) Pub. No.: US 2024/0376564 A1
(43) Pub. Date: Nov. 14, 2024

(54) BIO-LEACHING COMPOSITIONS AND METHODS FOR MINING METALS

(71) Applicant: LOCUS SOLUTIONS IPCO, LLC, SOLON, OH (US)

(72) Inventors: AMIR MAHMOUDKHANI, SOLON, OH (US); JONATHAN ROGERS, SOLON, OH (US); SEAN FARMER, FT. LAUDERDALE, FL (US); GABRIELA KNESEL, SOLON, OH (US)

(21) Appl. No.: 18/249,244

(22) PCT Filed: Jan. 18, 2023
(86) PCT No.: PCT/US2023/060823

§ 371 Date: Apr. 15, 2023

Related U.S. Application Data
(60) Provisional application No. 63/300,750, filed on Jan. 19, 2022.
(60) Provisional application No. 63/351,519, filed on Jun. 13, 2022.

(51) Int. Cl. C22B 3/18; C22B 3/06; C22B 11/00

(52) U.S. Cl. CPC C22B 3/18; C22B 3/06; C22B 11/04

(57) ABSTRACT

Bioleaching compositions for processing ores or other matter including metal or metal salt are presented, where the bioleaching composition includes a biosurfactant and metal solubilizing reagents. The biosurfactant can be a sophorolipid biosurfactant (SLP) and the metal solubilizing reagents include an acid and an oxidant or a microorganism. In methods of bioleaching using the bioleaching composition, the metals from the ores can be isolated from a solution phase or from a non-solution phase. The subject invention further provides compositions derived from microorganisms for pre-leaching treatments of the metal source, which can be used for reducing impurities in metal source. The use of the bioleaching composition enhances the rate of extraction and/or the throughput of the process.

### CROSS-REFERENCE TO RELATED APPLICATIONS

This application claims priority to U.S. Provisional Patent Application No. 63/300,750, filed Jan. 19, 2022, and 63/351,519, filed Jun. 13, 2022, each of which is incorporated herein by reference in its entirety.

### BACKGROUND OF THE INVENTION

“Leaching” is a widely used extractive metallurgy technique that converts metals found in ore (pieces of mineral, rock or soil) into soluble salts in aqueous media. There are a variety of leaching processes, usually classified by the types of reagents used. These techniques utilize either chemicals or microorganisms to extract metals, depending upon the ores or materials to be processed.

The large environmental footprint of mining and leaching begs for sustainable methods for metal extraction and recovery from mine tailings, slags and industrial residues. These sources typically display lower metal content but are available in very large quantities. However, the majority of metal-containing waste streams are directly placed in landfills, where they can be dissolved by rain and serve as sources of contamination for surface and ground waters. Currently, typical routes to minimize these waste streams primarily include immobilization in concrete and incineration, followed by compaction to reduce volume.

Hydrometallurgical extraction and concentration of metals from primary ores are normally carried out by froth flotation and leaching using strong acids, bases, solvents and/or surfactants. High yield and selective metal extractions from high grade ores suffer from toxic pollutants, handling problems, and the loss of lixiviant, such as sulfuric acid or sodium cyanide, through matrix interactions. These problems limit the extension of these processes to mining of low-grade metal sources.

More recently, biohydrometallurgy has immerged using microbially produced lixiviants for metal extraction and/or recovery and has been implemented for Cu and Au heap leaching. These autotrophic leaching technologies are derived from acidophilic microorganisms and, though effective for sulfidic matrices, are not generally effective for heterogeneous secondary sources. Biomolecules are compatible with sulfidic matrices, are stable during use, reuse, and recovery, and are biodegradable.

Microbial biosurfactants are formed using a biological process that is expected to become increasingly attractive for use as production costs decrease and quantities are scaled up for the introduction of new applications, such as biohydrometallurgy.

Safe and efficient recovery of metals is important. Therefore, novel, improved methods are needed for the processing of metals.

### BRIEF SUMMARY OF THE INVENTION

The subject invention relates generally to the recovery of metals. More specifically, the subject invention provides bioleaching compositions that, in certain embodiments, can be derived from microorganisms, wherein the compositions are useful for the mining or the recovery of metals from ores or other sources of metals, including from mine tailings, battery waste and waste devices, such as circuit boards. Methods are also provided for recovering valuable minerals and/or metals, such as, e.g., gold, copper, silver, lithium and cobalt, from ore and other sources of metals.

In preferred embodiments, the subject invention provides a bioleaching composition that can be employed in a method of recovering metals.

In preferred embodiments, the bioleaching composition comprises a biosurfactant-producing microorganism and/or a microbial growth by-product, either in crude form or purified form. In certain embodiments, the microbial growth by-product is a biosurfactant.

In specific preferred embodiments, the bioleaching composition comprises an aqueous solution of a biosurfactant. The biosurfactant can be present in the solution from less than one percent to more than ten percent of the mixture.

In certain embodiments, the biosurfactant is a glycolipid. In one embodiment, the biosurfactant is a sophorolipid (SLP), such as a linear SLP, lactonic SLP (acidic), acetylated SIP, de-acetylated SLP, salt-form SLP derivatives, esterified SLP derivatives, amino acid-SLP conjugates, and other SLP derivatives or isomers that exist in nature and/or are produced synthetically. The composition can also comprise mixtures of biosurfactants and/or biosurfactant subtypes.

In certain embodiments, the bioleaching composition further comprises a metal solubilizing agent, such as, for example, an acid-oxidant mixture or a metal-solubilizing microorganism.

The acid can be any acid that can solubilize an insoluble metal salt, such as, but not limited to, sulfuric acid, hydrochloric acid, nitric acid, phosphoric acid, and/or hydrocyanic acid (or a salt thereof). The acid can be used in a wide range of concentrations, from less than one percent to more than ten percent.

The oxidant can be selected from, for example, ferric chloride, chlorine, bromine, and oxygen. The oxidant can be used in sufficient quantity to liberate the target metal as a soluble salt but at quantities that minimize oxidant waste.

In certain exemplary embodiments, the bioleaching composition comprises a biosurfactant, an acid and an oxidant, wherein the biosurfactant is a sophorolipid, the acid is sulfuric acid, and the oxidant comprises Fe²⁺ or Fe³⁺.

In preferred embodiments, the subject invention provides methods for liberating a target metal from a source of said target metal, wherein a bioleaching composition of the subject invention is applied to the metal source. The metal source can be, for example, ore, mine tailings, slag and/or electronic waste from, for example, batteries and circuits.

In certain embodiments, the target metal is liberated as a soluble salt and/or a significant portion of any matrix that entraps the target metal is removed, thereby facilitating the isolation of the target metal from a non-soluble portion. For example, the bioleaching composition can be combined with a particulate ore that contains at least one target metal. The components can be mixed for reaction of the ore and at least one component of the bioleaching composition, such that a soluble metal-comprising solution and a non-solution phase is formed. In some embodiments, the particulate metal source is a fine powder. The particles in the fine powder can be less than about 1 m, about 75 cm, about 50 cm, about 25 cm, about 10 cm, about 75 mm, about 50 mm, about 25 mm, about 10 mm, about 5 mm, about 1 mm, about 100 μm, about 10 μm, about 1 μm, about 100 nm, about 10 nm, or about 1 nm in diameter.

Mixing of the bioleaching composition with the metal source can be performed via, for example, stirring, bubbling of a reactive or inert gas, ultrasonic mixing, piezoelectric agitation, or any combination thereof.

In certain embodiments, the solution comprising the soluble metal can be separated from the non-solution phase by, for example, decantation, filtration, centrifugation, or any combination thereof.

In certain embodiments, methods are provided for separating finely liberated target metals from gangue using froth flotation. In some embodiments, the method comprises aerating the target metals in water in the presence of a biosurfactant according to the subject invention, which facilitates the attachment of air bubbles to the target metal so that it floats to the surface of the liquid. At the surface, the target metals are supported by a froth layer and then collected. Unattached materials remain submerged in the liquid below. Advantageously, in certain embodiments, the biosurfactant modifies the surface properties of the target metal, selectively binding to the surface and imparting, for example, hydrophobicity to the metal to facilitate the attachment of air bubbles.

In some embodiments, methods of extracting a target metal from ore are provided wherein an ore in a particulate state is combined with a microorganism and/or bioleaching composition according to the subject invention to form a liquid slurry. The microbes can be live (or viable), or inactive at the time of application. In certain embodiments, the microorganisms can grow in situ and produce active compounds (e.g., metabolites) that can directly or indirectly solubilize metals.

The slurry can then be left and/or agitated for any amount of time sufficient to leach the target metal particles from the ore. The slurry can optionally be mixed and/or circulated continuously (e.g., mechanically or using aeration) throughout the leaching time period to ensure that maximum contact is made between the ore particles and the bioleaching composition.

Advantageously, the compositions and methods of the subject invention can be useful for liberating a wide variety of target metals including, but not limited to, aluminum, arsenic, cerium, cesium, chromium, cobalt, copper, dysprosium, erbium, europium, gadolinium, gallium, germanium, gold, hafnium, holmium, indium, iridium, lanthanum, lead, lithium, lutetium, magnesium, manganese, mercury, neodymium, nickel, niobium, palladium, platinum, praseodymium, rhodium, rubidium, ruthenium, samarium, scandium, silver, tantalum, tellurium, terbium, thallium, tin, titanium, tungsten, uranium, vanadium, ytterbium, yttrium, zinc, zirconium, any mixture thereof or any other rare earth or transition metal.

Advantageously, in certain embodiments, the bioleaching composition and methods of the subject invention are effective at standard leaching temperatures known in the metallurgical arts. In certain embodiments, the bioleaching composition and methods are useful at lower than standard temperatures, for example, at about 60° C. to 90° C. Thus, the subject invention provides methods of reducing the energy requirements for metal extraction and leaching while producing similar or improved yields.

Furthermore, in certain embodiments, the subject invention provides methods of enhancing the performance of standard leaching reagents, e.g., acids, oxidants and/or cyanide, wherein the reagents are applied alongside a biosurfactant and/or a biosurfactant-producing microbial culture according to the subject invention. Advantageously, in certain embodiments, the biosurfactant(s) of the subject bioleaching composition work in synergy with the leaching reagents, e.g., the acid and the oxidant, to improve their performance. This not only allows for potentially reduced volume usage of harsh leaching reagents, but also enhanced leaching yields with reduced time and/or energy expenditure.

In some embodiments, the metal source, such as, for example, ore, mine tailings, slag and/or electronic waste from, for example, batteries and circuits, can be treated with a pre-leaching composition before the leaching process. In certain embodiments, the method can further comprise, after obtaining the metal source, concurrent with the treatment by pre-leaching compositions of the subject invention, and/or after treating the metal source with the pre-leaching composition, subjecting the metal source to one or more beneficiation processes. The one or more beneficiation processes can include, for example, comminution, scrubbing, washing, screening, flotation, and/or hydrocycloning. In certain embodiments, the pre-leaching composition comprises a microbial biosurfactant. In certain embodiments, the composition comprises biosurfactants, and, optionally, other compounds, such as, for example, surfactants, pine oils, xanthates, or any combination thereof.

In certain embodiments, the pre-leaching composition according to the subject invention is effective due to amphiphile-mediated penetration of the metal source. In some embodiments, the sophorolipid or other biosurfactant serves as a vehicle for facilitating the transport of metal. For example, in some embodiments, a sophorolipid will form a micelle containing the metal, wherein the micelle is less than about 100 μm, less than about 10 μm, less than about 1 μm, less than about 100 nm, less than about 50 nm, less than about 25 nm, less than about 15 nm or less than about 10 nm, less than about 5 nm, or less than about 2 nm in size. The small size and amphiphilic properties of the micelle allow for enhanced penetration into the metal source so that greater contact can be made with metal therein.

In preferred embodiments, the method comprises flotation of the target metals pre-leaching composition according to the subject invention, which facilitates the attachment of air bubbles to the target metal so that it floats to the surface of the liquid during aeration. At the surface, the target metals are supported by a froth layer and then collected. Unattached materials remain submerged in the liquid below. Advantageously, in certain embodiments, the biosurfactant modifies the surface properties of the target metal, selectively binding to the surface and imparting hydrophobicity to the metal to facilitate the attachment of air bubbles.

### BRIEF DESCRIPTION OF THE FIGURES

FIG. 1 shows a comparison of pH readings for one control leaching treatment comprising no biosurfactant and three biosurfactant-containing leaching treatments at 60° C. over a period of 7 days.

FIG. 2 shows a comparison of Eh readings for one control leaching treatment comprising no biosurfactant and three biosurfactant-containing leaching treatments at 60° C. over a period of 7 days.

FIG. 3 shows a comparison of Cu-Sulfide measured in a feed sample of low-grade copper ore, as well as measurements from residue after treatment with one control leaching treatment comprising no biosurfactant and three biosurfactant-containing leaching treatments at 60° C. over a period of 7 days.

### DETAILED DESCRIPTION

The subject invention provides materials and methods for the removal and/or isolation of metals from tailings, slag or other sources of metals, wherein, in certain embodiments, the metal is leached from the source in the form of a water-soluble salt. In embodiments of the invention, the source of the metal, the “ore,” may be a waste material, such as battery tailings or an electrical device, for example a printed circuit board, where the metals are more readily liberated into solution or otherwise separated from the waste.

Advantageously, the compositions and methods of the subject invention reduce volume usage of harsh and/or toxic leaching reagents, such as acids, oxidants and cyanide; enhance performance of existing leaching reagents, even at reduced temperatures (e.g., 60° C. to 90° C.); and reduce energy and time required to produce a desired metal extraction yield.

### Selected Definitions

As used herein, “applying” a composition or product refers to contacting it with a target or site such that the composition or product can have an effect on that target or site. The effect can be due to, for example, microbial growth and/or the action of a biosurfactant or other microbial growth by-product.

As used herein, an “isolated” or “purified” nucleic acid molecule, polynucleotide, polypeptide, protein or organic compound such as a small molecule (e.g., those described below), is substantially free of other compounds, such as cellular material, with which it is associated in nature. A purified or isolated polynucleotide (ribonucleic acid (RNA) or deoxyribonucleic acid (DNA)) is free of the genes or sequences that flank it in its naturally-occurring state. A purified or isolated polypeptide is free of the amino acids or sequences that flank it in its naturally-occurring state. An isolated microbial strain means that the strain is removed from the environment in which it exists in nature. Thus, the isolated strain may exist as, for example, a biologically pure culture, or as spores (or other forms of the strain) in association with a carrier.

In certain embodiments, purified compounds are at least 60% by weight the compound of interest. Preferably, the preparation is at least 75%, more preferably at least 90%, and most preferably at least 98%, by weight the compound of interest. For example, a purified compound is one that is at least 80%, 85%, 90%, 91%, 92%, 93%, 94%, 95%, 98%, 99%, or 100% (w/w) of the desired compound by weight. Purity is measured by any appropriate standard method, for example, by column chromatography, thin layer chromatography, or high-performance liquid chromatography (HPLC) analysis.

A “metabolite” refers to any substance produced by metabolism or a substance necessary for taking part in a particular metabolic process. A metabolite can be an organic compound that is a starting material, an intermediate in, or an end product of metabolism. Examples of metabolites include, but are not limited to, enzymes, acids, solvents, alcohols, proteins, vitamins, minerals, microelements, amino acids, biopolymers and biosurfactants.

Ranges provided herein are understood to be shorthand for all of the values within the range. For example, a range of 1 to 20 is understood to include any number, combination of numbers, or sub-range from the group consisting 1, 2, 3, 4, 5, 6, 7, 8, 9, 10, 11, 12, 13, 14, 15, 16, 17, 18, 19 and 20, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

As used herein a “reduction” means a negative alteration, and an “increase” means a positive alteration, wherein the negative or positive alteration is at least 0.001%, 0.01%, 0.1%, 0.5%, 1%, 5%, 10%, 15%, 20%, 25%, 30%, 35%, 40%, 45%, 50%, 55%, 60%, 65%, 70%, 75%, 80%, 85%, 90%, 95% or 100%.

As used herein, “ore” refers to a naturally occurring solid material from which a valuable substance, mineral and/or metal can be profitably extracted. Ores are often mined from ore deposits, which comprise ore minerals containing the valuable target metal. Other “Gangue” minerals are minerals containing non-target metals that occur in the deposit. Examples of ore deposits include hydrothermal deposits, magmatic deposits, laterite deposits, volcanogenic deposits, metamorphically reworked deposits, carbonatite-alkaline igneous related deposits, placer ore deposits, residual ore deposits, sedimentary deposits, sedimentary hydrothermal deposits and astrobleme-related deposits. Ores, as used herein, however, can also include ore concentrates or tailings, coal or coal waste products, or even other sources of metal or valuable minerals, including but not limited to, jewelry, electronic scraps, batteries and other scrap materials.

As used herein, “leaching” refers to the process by which a metal is separated from a metal source, such as, for example, ore, mine tailings, slag and/or electronic waste from, for example, batteries and circuits by aqueous solutions including by, for example, cyanide leaching, ammonia leaching, alkali leaching, or acid leaching.

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention. Use of the term “comprising” contemplates other embodiments that “consist” or “consist essentially of” the recited component(s).

Unless specifically stated or obvious from context, as used herein, the term “or” is understood to be inclusive. Unless specifically stated or obvious from context, as used herein, the terms “a,” “and” and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof.

All references cited herein are hereby incorporated by reference in their entirety.

### Pre-Leaching and Bioleaching Compositions

The subject invention provides bioleaching compositions comprising one or more metal solubilizing agents and an adjuvant, or performance booster, for the one or more metal solubilizing agents, wherein the accelerant is a biosurfactant-producing microorganism and/or a biosurfactant.

In an exemplary embodiment, the composition comprises a biosurfactant and one or more metal solubilizing agents, wherein the metal solubilizing agent is an acid, an oxidant, an acid-oxidant mixture, or a microbial leaching agent, wherein the biosurfactant serves as an acid leaching accelerant, a bio-oxidation accelerant, and/or a bioleaching accelerant.

In certain embodiments, the bioleaching composition comprises a microbe-based product comprising a biosurfactant utilized in crude form. The crude form can comprise, in addition to the biosurfactant, fermentation broth in which a biosurfactant-producing microorganism was cultivated, residual microbial cell matter or live or inactive microbial cells, residual nutrients, and/or other microbial growth by-products. The product may be, for example, at least, by weight, 1%, 5%, 10%, 25%, 50%, 75%, or 100% broth. The amount of biomass in the product, by weight, may be, for example, anywhere from 0% to 100% inclusive of all percentages therebetween.

In certain embodiments, the subject invention provides pre-leaching compositions comprising components that are derived from microorganisms. In certain embodiments, the pre-leaching composition comprises a microbial biosurfactant. In certain embodiments, the composition comprises a biosurfactant, and, optionally, one or more of chemical surfactants, pine oils, xanthates, or any combination thereof.

In certain embodiments, the pre-leaching composition comprises a microbe-based product comprising a biosurfactant utilized in crude form. The crude form can comprise, in addition to the biosurfactant, fermentation broth in which a biosurfactant-producing microorganism was cultivated, residual microbial cell matter or live or inactive microbial cells, residual nutrients, and/or other microbial growth by-products. The product may be, for example, by weight, at least, 1%, 5%, 10%, 25%, 50%, 75%, or 100% broth. The amount of biomass in the product, by weight, may be, for example, anywhere from 0% to 100% inclusive of all percentages therebetween.

In some embodiments, the biosurfactant can be included in the pre-leaching composition at 0.01 to 99.9%, 0.1 to 90%, 0.5 to 80%, 0.75 to 70%, 1.0 to 50%, 1.5 to 25%, or 2.0 to 15% by weight, with respect to the total pre-leaching composition.

In another embodiment, purified biosurfactants may be added in combination, optionally, with an acceptable carrier, to the pre-leaching composition, in that the biosurfactant may be presented at concentrations of 0.001 to 50% (v/v), preferably, 0.01 to 20% (v/v), more preferably, 0.02 to 5% (v/v).

In some embodiments, the biosurfactant can be included in the pre-leaching composition at, for example, 0.01 to 100,000 ppm, 0.05 to 10,000 ppm, 0.1 to 1,000 ppm, 0.5 to 750 ppm, 1.0 to 500 ppm, 2.0 to 250 ppm, or 3.0 to 100 ppm, with respect to the amount of the metal source being treated.

In certain embodiments, the chemical surfactant of the pre-leaching composition is a detergent, wetting agent, emulsifier, foaming agent, and/or dispersant. In some embodiments, the chemical surfactant can be included in the pre-leaching composition at 0.01 to 99.9%, 0.1 to 90%, 0.5 to 80%, 0.75 to 70%, 1.0 to 50%, 1.5 to 25%, or 2.0 to 15% by weight, with respect to the total pre-leaching composition.

In certain embodiments, the pine oil of the pre-leaching composition comprises a-terpineol, terpene alcohols, terpene hydrocarbons, terpene ethers, terpene esters, or any combination thereof. In some embodiments, the pine oil can be included in the composition at 0.01 to 99.9%, 0.1 to 90%, 0.5 to 80%, 0.75 to 70%, 1.0 to 50%, 1.5 to 25%, or 2.0 to 15% by weight, with respect to the total pre-leaching composition.

In certain embodiments, the xanthate of the pre-leaching composition is sodium ethyl xanthate, potassium ethyl xanthate, sodium isopropyl xanthate, sodium isobutyl xanthate, potassium amyl xanthate, or any combination thereof. In some embodiments, the xanthate can be included in the composition at 0.01 to 99.9%, 0.1 to 90%, 0.5 to 80%, 0.75 to 70%, 1.0 to 50%, 1.5 to 25%, or 2.0 to 15% by weight, with respect to the total pre-leaching composition.

The pre-leaching composition can further comprise other additives such as, for example, carriers, other microbe-based compositions, additional biosurfactants, enzymes, catalysts, solvents, salts, buffers, chelating agents, acids, emulsifying agents, lubricants, solubility controlling agents, preservatives, stabilizers, ultra-violet light resistant agents, viscosity modifiers, preservatives, tracking agents, biocides, and other microbes and other ingredients specific for an intended use.

In some embodiments, the biosurfactant is utilized after being extracted from a fermentation broth and, optionally, purified.

In specific preferred embodiments, the bioleaching composition comprises an aqueous solution of a biosurfactant. The biosurfactant can be present in the solution from, for example, less than one percent to more than ten percent of the mixture.

As used herein, “surfactant” means a compound that lowers the surface tension (or interfacial tension) between two liquids or between a liquid and a solid. Surfactants act as, e.g., detergents, wetting agents, emulsifiers, foaming agents, and/or dispersants. A “biosurfactant” is a surface-active substance produced by a living cell and/or using naturally derived substrates. Like chemical surfactants, each biosurfactant molecule has its own hydrophobic-lipophilic balance (HLB) value depending on its structure; however, unlike production of chemical surfactants, which results in a single molecule with a single HLB value or range, one cycle of biosurfactant production typically results in a mixture of biosurfactant molecules (e.g., subtypes and isomers thereof).

Biosurfactants are a structurally diverse group of surface-active substances consisting of two parts: a polar (hydrophilic) moiety and non-polar (hydrophobic) group. Due to their amphiphilic structure, biosurfactants can, for example, increase the surface area of hydrophobic water-insoluble substances, increase the water bioavailability of such substances, and change the properties of bacterial cell surfaces. Biosurfactants can also reduce the interfacial tension between water and oil and, therefore, lower the hydrostatic pressure required to move entrapped liquid to overcome the capillary effect. Biosurfactants accumulate at interfaces, thus reducing interfacial tension and leading to the formation of aggregated micellar structures in solution. The formation of micelles provides a physical mechanism to mobilize, for example, oil in a moving aqueous phase. The phrases “biosurfactant” and “biosurfactant molecule” include all forms, analogs, orthologs, isomers, and natural and/or anthropogenic modifications of any biosurfactant class (e.g., glycolipid) and/or subtype thereof (e.g., sophorolipid).

Typically, the hydrophilic group of a biosurfactant is a sugar (e.g., a mono-, di-, or polysaccharide) or a peptide, while the hydrophobic group is typically a fatty acid. Thus, there are countless potential variations of biosurfactant molecules based on, for example, type of sugar, number of sugars, size of peptides, which amino acids are present in the peptides, fatty acid length, saturation of fatty acids, additional acetylation, additional functional groups, esterification, polarity and charge of the molecule.

These variations lead to a group of molecules useful according to the subject methods, comprising a wide variety of classes, including, for example, glycolipids (e.g., sophorolipids, rhamnolipids, cellobiose lipids, mannosylerythritol lipids and trehalose lipids), lipopeptides (e.g., surfactin, iturin, fengycin, arthrofactin and lichenysin), flavolipids, phospholipids (e.g., cardiolipins), fatty acid ester compounds, and high molecular weight polymers such as lipoproteins, lipopolysaccharide-protein complexes, and polysaccharide-protein-fatty acid complexes. Each type of biosurfactant within each class can further comprise subtypes having further modified structures.

In embodiments of the invention, the acid leaching accelerant, bioleaching accelerant, bio-oxidation accelerant, and/or the biosurfactant, is a “sophorolipid,” “sophorolipid molecule,” “SLP” or “SLP molecule” includes all forms, and isomers thereof. The SLP molecule, can be, for example, an acidic (linear) SLP (ASL) and/or a lactonic SLP (LSL). Other SLPs that can be employed, alone, or in addition to an ASL and/or LSL, include a mono-acetylated SLP, di-acetylated SLP, esterified SLP, SLP with varying hydrophobic chain lengths, cationic and/or anionic SLP with fatty acid-amino acid complexes attached, esterified SLP, SLP-salt derivatives (e.g., a sodium salt of a linear SLP), and/or other types of SLPs. These biosurfactants are environmentally friendly.

The ASL and LSL molecules that are employed are, in some embodiments represented by General Formula (1) and/or General Formula (2), below, and are obtained as a collection of 30 or more types of structural homologues having different fatty acid chain lengths (R³), and, in some instances, having an acetylation or protonation at R¹ and/or R².

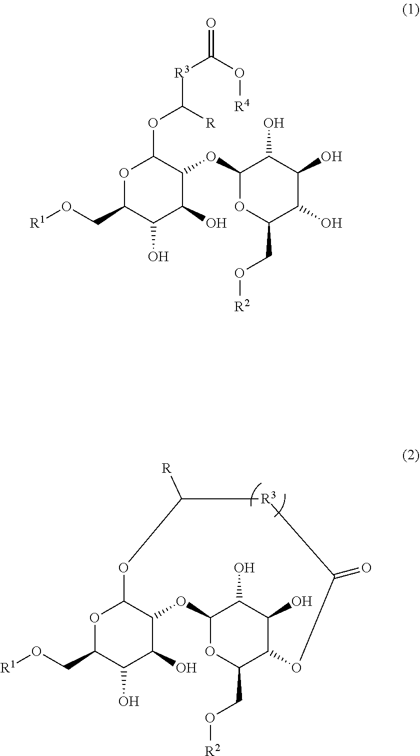

In Formula (1) or (2), R can be either a hydrogen atom or a methyl group. One or both of R¹ and R² are independently a hydrogen atom or an acetyl group. R³ is a saturated, unsaturated, or multiply unsaturated hydrocarbon chain that may have one or more substituents. Independently, substituents at one or more of any carbons of R³ can include halogen, hydroxyl, C₁₋₆ alkyl, halogen substituted C₁₋₆ alkyl, hydroxy substituted C₁₋₆ alkyl, or halogen substituted C₁₋₆ alkoxy groups. R³ typically has 11 to 20 carbon atoms or any subset thereof, for example, 13 to 17 carbon atoms or 14 to 16 carbon atoms. R⁴ can be a hydrogen, an alkali metal, or a C₁₋₆ alkyl group.

SLP are typically produced by yeasts, such as Starmerella spp. yeasts and/or Candida spp.

yeasts, e.g., Starmerella (Candida) bombicola, Candida apicola, Candida batistae, Candida floricola, Candida riodocensis, Candida stellate and/or Candida kuoi. SLP have environmental compatibility, high biodegradability, low toxicity, high selectivity and specific activity in a broad range of temperature, pH and salinity conditions. Additionally, in some embodiments, SLP can be advantageous due to their small micelle size, which can help facilitate the movement of the micelle, and compounds enclosed therein, through nanoscale pores and spaces. In certain embodiments, the micelle size of a SLP is less than about 100 μm, less than about 10 μm, less than about 1 μm, less than about 100 nm, less than about 50 nm, less than about 20 nm, less than about 15 nm, less than about 10 nm, less than about 5 nm, or less than about 2 nm.

In some embodiments, the biosurfactant can be included in the bioleaching composition at 0.01 to 99.9%, 0.1 to 90%, 0.5 to 80%, 0.75 to 70%, 1.0 to 50%, 1.5 to 25%, or 2.0 to 15% by weight, with respect to the total bioleaching composition.

In some embodiments, the biosurfactant can be included in the bioleaching composition at, for example, 0.01 to 100,000 ppm, 0.05 to 10,000 ppm, 0.1 to 1,000 ppm, 0.5 to 750 ppm, 1.0 to 500 ppm, 2.0 to 250 ppm, or 3.0 to 100 ppm, with respect to the amount of the metal source being treated.

In another embodiment, purified biosurfactants may be added in bioleaching combination with an acceptable carrier, in that the biosurfactant may be presented at concentrations of 0.001 to 50% (v/v), preferably, 0.01 to 20% (v/v), more preferably, 0.02 to 5% (v/v).

In certain specific embodiments, the bioleaching or pre-leaching compositions comprise a mixture of ASL and one or more other SLP molecules, such as, for example, LSL. In one embodiment, the percentage of ASL in the composition is about 20% to 50%, or 25% to 30% (with 100% being the sum of the amount of SLP molecules). In one embodiment, the percentage of ASL is over 50% with respect to the total sum of SLP molecules. In another embodiment, the percentage of ASI, is over 75%, over 90%, or over 99% with respect to the total sum of SLP molecules.

In order to achieve higher ratios of ASL over the LSL and/or other SLP molecules, the mixture can be subjected to purification via, for example, solvent extraction, alkaline hydrolysis, water washing, oil washing and/or as described in International Patent Publication WO 2021/127339 A1, incorporated herein by reference.

In some embodiments, the bioleaching or pre-leaching compositions comprise further components such as cellular matter, broth components, residual feedstock materials (e.g., fatty acids, glucose), and/or additional metabolites from the SLP-producing microorganism that are present at a concentration of, for example, from 50% to 0.001%, from 40% to 1%, or from 25% to 5%, of the total composition volume. In certain embodiments, one or more of these additional components contributes to enhanced activity of the bioleaching composition, compared with the activity of bioleaching compositions comprising higher purity biosurfactant mixtures containing, for example, less than 15%, less than 10%, less than 5%, or less than 1% non-SI.P materials and/or components.

In certain embodiments, the bioleaching composition comprises an acid. In some embodiments, acid is an organic acid, such as, for example, acetic acid, citric acid, lactic acid, butyric acid, sorbic acid, benzoic acid, formic acid, fumaric acid, propionic acid, ascorbic acid, glyoxylic acid, malonic acid, pyruvic acid, oxalic acid, uric acid, malic acid, tartaric acid and/or analogs thereof. In certain embodiments, the acid is selected from inorganic acids such as, for example, sulfuric acid, nitric acid, phosphoric acid, hydrochloric acid, hydrofluoric acid, boric acid and analogs thereof. In preferred embodiments, the acid is a strong acid, such as sulfuric acid.

In some embodiments, the acid can be included in the composition at 0.01 to 99.9%, 0.1 to 90%, 0.5 to 80%, 0.75 to 70%, 1.0 to 50%, 1.5 to 25%, or 2.0 to 15% by weight, with respect to the total bioleaching composition

In certain embodiments, the bioleaching composition comprises an oxidant. In some embodiments, the oxidant is, for example, ferric chloride, chlorine, bromine, or oxygen. The oxidizer can further be selected from, for example, a ferric salt, commonly ferric sulfate, or a ferric salt with an anion equivalent of the acid in full dissociated form.

In some embodiments, the oxidant can be included in the composition at 0.01 to 99.9%, 0.1 to 90%, 0.5 to 80%, 0.75 to 70%, 1.0 to 50%, 1.5 to 25%, 2.0 to 15%, or less than about 7.0% by weight, with respect to the total bioleaching composition.

The bioleaching composition can further comprise other components such as, for example, carriers, other microbe-based compositions, additional biosurfactants or chemical surfactants, other leaching reagents (e.g., cyanide, microbial leaching agents), enzymes, catalysts, solvents, salts, buffers, chelating agents, acids, emulsifying agents, lubricants, solubility controlling agents, preservatives, stabilizers, ultra-violet light resistant agents, viscosity modifiers, preservatives, tracking agents, biocides, and other microbes and other ingredients specific for an intended use.

### Pre-Leaching Methods

In certain embodiments, the subject invention provides a method for extracting impurities from a metal source. In certain embodiments, the subject invention provides a method for removing impurities from a metal source, wherein the method comprises the step of: (i) obtaining the metal source, said metal source comprising a metal and an impurity; (ii) contacting a pre-leaching composition according to the subject invention with the metal source for a period of time to yield a mixture comprising a treated metal source and an impurity; and (iii) separating the impurity and pre-leaching composition with the metal from the mixture. The method can be carried out, in situ, in a heap leach pad, a column, or any other laboratory or industrial sized reactor.

In some embodiments, step (i) comprises grinding the obtained metal source into a fine powder. The particles in the powder can be less than about 1 m, about 75 cm, about 50 cm, about 25 cm, about 10 cm, about 75 mm, about 50 mm, about 25 mm, about 10 mm, about 5 mm, about 1 mm, about 100 μm, about 10 μm, about 1 μm, about 100 nm, about 10 nm, about 1 nm in diameter.

In some embodiments, step (ii) comprises applying a pre-leaching composition comprising a biosurfactant and, optionally, water, other surfactants, pine oils, and xanthates, to the metal source. In certain embodiments, air can be pumped into the mixture and the metal and biosurfactants can rise to the top of mixture, creating a froth. In some embodiments, the froth can be removed and tailings or other non-metal containing components can be removed from the mixture. Step (ii) can be repeated as many times as necessary to achieve a desired reduction in impurity content.

In certain embodiments, the time period of step (ii) is from 1 minute to 48 hours, about 30 minutes to 40 hours, or preferably about 12 hours to 24 hours. In certain embodiments, step (ii) comprises applying a liquid form pre-leaching composition to the metal source to produce a liquid mixture and stirring or otherwise agitating the liquid mixture for the period of time.

In some embodiments, when step (ii) is carried out in liquid, the impurity is present in the aqueous phase and the metal floats in a froth above the aqueous phase that can be removed from the liquid.

In some embodiments, step (iii) comprises applying a leaching solution and optionally, mixing under agitation (e.g., shaking or stirring) for a period of time (e.g., 10 hours to 48 hours). The leaching solution will comprise the impurity, pre-leaching composition, and the metal that is to be removed from the fluid.

In certain embodiments, the method comprises (a) obtaining the metal source, said metal source comprising a metal and an impurity; (b) applying a pre-leaching composition according to the subject invention to the metal source under agitation for a period of time to yield a mixture comprising a treated metal source and an impurity; (c) preparing a slurry of the metal source in water and maintaining the slurry under agitation and air bubbling, thereby causing the formation of a froth comprising the treated metal source and an aqueous layer comprising impurities; and (e) separating the treated metal from the aqueous layer.

In some embodiments, step (e) comprises applying a leaching solution to the mixture, optionally under agitation (e.g., shaking or stirring) for a period of time (e.g., about 10 hours to about 48 hours). The leaching solution will comprise the impurity, pre-leaching composition, and the metal that is to be removed from the fluid.

The methods of the subject invention can be carried out at ambient temperature, and/or at a temperature of about 15° C. to about 50° C., about 20° C. to about 40° C., about 20° C. to about 35° C., about 20° C. to about 30° C., about 25° C., about 40° C. to 120° C., about 50° C. to about 100° C., about 60° C. to about 100° C., about 70° C. to about 100° C., about 80° C. to about 100° C., or about 100° C. In certain embodiments, a temperature higher than ambient temperature can be provided using, for example, a microwave, ultrasound, induction heating, plasma, electricity, or any combination thereof.

The methods of the subject invention can be carried out at ambient pressure, and/or at a pressure of about 50 bars, 75 bar, 100 bars, or greater than 100 bars.

In certain embodiments, the amount of the pre-leaching composition applied is about 0.1 to 15%, about 0.1 to 10%, about 0.1 to 5%, about 0.1 to 3%, about 0.1%, or about 1 vol % based on an amount of the metal-containing material.

In certain embodiments, the methods of the subject invention result in at least 25% reduction in impurities content, preferably at least 50% reduction, after one treatment. In some embodiments, the metal source can be treated multiple times to further reduce the impurities content.

In certain embodiments, the pre-leaching composition according to the subject invention is effective due to amphiphiles-mediated penetration of the metal source. In some embodiments, the sophorolipid or other biosurfactant serves as a vehicle for facilitating the transport of a metal. For example, in some embodiments, a sophorolipid will form a micelle containing the metal, wherein the micelle is less than about 100 μm, less than about 10 μm, less than about 1 μm, less than about 100 nm, less than about 50 nm, less than about 25 nm, less than about 15 nm, less than about 10 nm, less than about 5 nm, or less than about 2 nm in size. The small size and amphiphilic properties of the micelle allow for enhanced penetration into the metal source so that greater contact can be made with metal therein.

In one embodiment, the method comprises crushing, grinding or pulverizing the metal source into smaller particles, for example, less than about 1 m, about 75 cm, about 50 cm, about 25 cm, about 10 cm, about 75 mm, about 50 mm, about 25 mm, about 10 mm, about 5 mm, about 1 mm, about 100 μm, about 10 μm, about 1 μm, about 500 nm, about 100 nm, about 50 nm, about 10 nm, about 5 nm, about 1 nm in diameter, prior to treating with the pre-leaching composition.

In some embodiments, the metal source is obtained from an ore deposit or other source in a raw form. This raw form can comprise additional materials, or gangue. Thus, in certain embodiments, the method can further comprise, after obtaining the metal source concurrent with the treatment with the subject pre-leaching compositions, and/or after treating the metal source with the pre-leaching composition, subjecting the metal source to one or more beneficiation processes. The one or more beneficiation processes can include, for example, comminution, scrubbing, washing, screening, flotation, and/or hydrocycloning. In certain embodiments, the subject compositions can be used in one or more beneficiation processes, such as, for example, flotation. The subject compositions can be added to compositions used for flotation. Additionally, the subject compositions can replace, or reduce the use of, one or more components of a composition used for flotation, such as, for example, a chemical surfactant.

Advantageously, in certain embodiments, the pre-leaching composition according to the subject invention provides enhanced or increased efficiency at removing impurities from metal with limited negative environmental impacts. Additionally, the methods of the subject invention do not require complicated equipment or high energy consumption, and production of the pre-leaching composition can be performed on site, for example, at a metal recycling facility, an ore mine, or a leaching site. In certain embodiments, the subject pre-leaching composition can result in a decreased use of chemical surfactants or other potentially harmful chemicals during processing of a metal. Furthermore, the reduced-impurity metal materials produced according to the subject invention can be useful for producing more environmentally-friendly, metal products.

### Bioleaching Methods

The subject invention provides compositions and methods for the removal and/or isolation of metals from tailings, slag or other sources of metals. The leaching process is enhanced by the incorporation of a biosurfactant in the present bioleaching composition. In certain embodiments, the bioleaching methods can be performed after the pre-leaching methods are performed. In alternative embodiments, the bioleaching methods are performed instead of the pre-leaching methods.

Bioleaching methods can be carried out, in situ, in a heap leach pad, a column, or any other laboratory or industrial sized reactor. The metals generally exist in ores as insoluble salts, such as sulfides, oxides, silicates, carbonates, or mixed anion salts.

In some embodiments, the presence of a metal solubilizing agent in the bioleaching composition, for example, an aqueous strong acid/oxidizer solution or an aqueous weak acid/oxidizer solution facilitates conversion of insoluble metal salts into soluble metal salts dissolved in water. In an exemplary embodiment, the strong acid can be sulfuric acid, though other acids can be employed, and the oxidizer can be, for example, a ferric salt, commonly ferric sulfate, or a ferric salt with an anion equivalent of the acid in full dissociated form.

Generally, the metal source is crushed or milled to increase the surface area, although the generation of a preponderance of fine particles can be problematic, as they can agglomerate and cause undesired channeling when a percolation process is employed. Smaller particles generally result in higher metal yields in shorter process times, though the advantageous throughput and yield must be balanced with the increased energy and costs of producing the finer particles.

The process can be, but is not necessarily, carried out at elevated temperatures. Temperatures of about 60° C. to about 150° C., or more, can be used. Advantageously, the subject invention is useful even at the lower end of this range, for example from 60° C. to 90° C.

The bioleaching composition can be agitated to accelerate the process. Flow can either be upward, downward, or a counter current can be employed. The reactor can be agitated to promote the reaction where agitation is by bubbling of a reactive or inert gas, stirring, ultrasonic mixing, piezoelectric agitation or any other mode of mixing or agitation.

In certain embodiments, the solution comprising the soluble metal can be separated from the non-solution phase by, for example, decantation, filtration, centrifugation, or any combination thereof.

The amount of acid and oxidizer can be controlled to optimize the metal precipitating when, in a subsequent isolation step, a reducing agent, generally another metal, such as iron, is added to promote the precipitation of a metal of fine particle size. Alternatively, the metal sulfate solution is submitted to electrolysis to plate out the metal.

Specific embodiments of the subject invention are directed to the generation and removal of metals from ore, tailings, slag or other sources of one or more target metals where the metal is leached from the source in the form of a water-soluble salt. The metals generally exist in ores as the reduced metal, such as, but not limited to gold. In the presence of a leaching agent, an aqueous alkali metal, alkali earth metal cyanide, or hydrocyanic acid solution, the metal oxidizes to a metal cyanide salt in aqueous solution phase.

In some embodiments, the method comprises crushing, grinding or pulverizing the ore into smaller particles to, for example, increase the surface area. For example, grinding can achieve particles that are less than about 500 μm in size, or any other size, for example, but not limited to about 100 μm, prior to contacting with the leaching solution comprising the biosurfactant. In other embodiments, the biosurfactant or a solution comprising the biosurfactant is included with the ore during the crushing of the ore. The aqueous solution can be of any pH that enhances the crushing and surface treatment or transformation structurally or chemically to enhance leaching. In some embodiments, the target metal in a reduced state is not oxidized, but the matrix in which it is embedded is degraded to liberate the target metal as a solid non-solution phase.

The biosurfactant can improve the process by stabilizing the liquid-solid interface and accelerating the chemical exchange at the liquid-solid interface. In some embodiments, the biosurfactant can form complexes with the metal ions to accelerate desorption of the metal ions from the particle surface. The biosurfactant promotes conversion of any passivating metal sulfide layer by its oxidization and displacement from the surface to enhance the penetration of the acidic oxidant into the ore particles.

The use of the biosurfactant allows the minimization of excess acid and oxidant in the leaching process. It also accelerates the process by improving the liquid-solid interface. The consequence of the inclusion can be an efficiency increase that can permit, when economically advantageous, a lowering in temperatures and pressures, as an alternative to the improved throughputs and yields.

The biosurfactants can be included for acceleration of the process and/or enhancement of yield by the stabilization of the liquid-solid interface for oxidation of the sulfides to soluble metal sulfates in any process including the processes known as:

BioNIC where microorganisms are used with water and air to leach soluble metals, typically from a stirred tank with ores that contain iron sulfides to provide a source of ferric ions.

Intec Nickel Process (INP) where a halide is included as the oxidant in a process carried out in a heated aqueous suspension of sulfide ores, primarily of nickel, copper, or cobalt.

CESL Nickel Process for the leaching of copper and other metals from sulfide ores at slightly elevated temperatures, about 150° C., and pressures, about 1,400 kPa, in the presences of acid and oxygen.

Activox Process where ultra-fine grinding is employed to activate the mineral surface for oxidative leaching at about 100 to about 110° C. and about 1,000 kPa, has been used to break the sulfide matrix with the solubilization of metals, such as copper, nickel, and cobalt, and the concentration of gold, silver, and platinum in the leach residue for recovery.

FL.Smidth Rapid Oxidative Leach Process (ROL) is a mechano-chemical process, where sulfide ores are treated at about 80° C. and atmospheric pressure using acidic ferric sulphate and an oxygen flow with interstage and/or intrastage attrition.

Metals that are isolated in a solution phase and those isolated in the non-solution phase formed in the process can be different, or in some cases, depending on the solubilizing agent, be the same metal. For example, in some cases, Au can be isolated from the solution phase and in other cases can be isolated from the non-solution phase. Common exemplary solution phase liberated metals, include, but are not limited to Cu, Zn, Ni, Co, Ur, Mn, Li, Al, and Sn. Non-solution phase isolatable metals, or non-metals, include, but are not limited to Au, Ag, Pt, and graphite. These can be isolated more rapidly and/or in higher yield by inclusion of the biosurfactants, and their addition extends to traditional and evolving biomining techniques.

In one embodiment, gold mining using a cyanide process can be improved by the use of a biosurfactant. The efficiency of exposing the gold surface to the cyanide solution enabled by the biosurfactant allows the minimization of the quantity of cyanide required to generate the Au(CN)₂ with little or no Au or cyanide remaining in the leaching system. In other embodiments, the gold remains in reduced form when embodiments employ an acid and an oxidant that removes a matrix from the reduced metal to liberate gold particles in the non-solution phase.

In some embodiments, the acid leaching of heavy metals from contaminated soil can be carried out using hydrochloric acid/nitric acid, (qua regia) or other acids or acid mixtures in the presence of the biosurfactant. The heavy metals that are advantageously removed from the soil with the inclusion of a biosurfactant include, but are not limited to, As, Co, Cr, Ni, Pb, V, Hg and Zn.

In embodiments of the invention where the bioleaching is carried out where the solubilizing agent used is not chemical but is a microorganism that generates the required chemicals, the microorganism can be Acetobacter metanolicus, Acidianus brierleyi, Acidophillum cryptum, Acinomucor sp., Alternaria sp., Artrobacter Sp., Aspergillus amstelodami, Aspergillus clavatus, Aspergillus ficuum, Aspergillus fumigatus, Aspergillus niger, Aspergillus ochraceus, Bacillus sp., Bacillus megaterium, Bacillus polymyxa, Brettanomyces lambicus, Candida sp., Cerostamella sp. Chlorella vulgaris, Chromobacterium violacerum, Cladosprium resinae, Clostridium sp., Coriolus versicolor, Corynebacterium sp., Crenothrix sp., Cunninghamiella sp., Fusarium sp., Gallionella sp., Gleophyllum trabeum, Leptospirilum ferroomidans, Leptospirillum thermoferrooxidans, Leptotrix sp., Metallogenium sp., Metallosphaera sedula, Mucor sp., Paecilomyces variotii, Penicillium brevicompactum, Penicillium cyclopium, Penicillium funiculosum, Penicillium notatum, Penicillium ochrochloron, Penicillium oxalicum, Penicillium simlicissimum, Penicillium spinulosum, Penicillium variotii, Phanerochaete chrusosporium, Pichia sp., Pseudomonas putida, Rhizopus sp., Saccharomyces cerevisiae, Sulfobacillus thermosulfidooxidans, Sulfobacillus thermosulfidooxidans sub. Thermotolerans, Sulfobacillus thermosulfidooxidans sub. Asporogenes, Sulfolobus acidocaldarius, Sulfolobus ambivalens, Sulfolobus solfataricus, Sulfolobus thermosulfidoxidans, Sulfolobus brierlei, Sulfolobus yellowstonii, Sulfurococcus sp., Thermothrix thipara, Thiobacillus sp., Thiobacillus acidophilus, Thiobacillus albertis, Thiobacillus capsulatus, Thiobacillus concretivorus, Thiobacillus caprinus, Thiobacillus delicatus, Thiobacillus denitrificans, Thiobacillus ferrooxidans, Thiobacillus intermedius, Thiobacillus kabobis, Thiobacillus neapolitanus, Thiobacillus novellus, Thiobacillus organoparus, Thiobacillus perometabolis, Thiobacillus prosperous, Thiobacillus rubellus, Thiobacillus tepidarius, Thiobacillus thiocynoxidans, Thiobacillus thiooxidans, Thiobacillusthioparys, Thiobacillus versutus, Trametes versicolor, Trichoderma Harzianum, Tichoderma viride, Yarrowia lipolytica, or any other bacteria, fungi, or archaea that can generate an acid, ferric salt, or cyanide.

In certain embodiments, methods are provided for separating finely liberated target metals from waste gangue using froth flotation. In some embodiments, the method comprises obtaining a target metal from ore by, e.g., crushing and grinding the ore to liberate the mineral particles; applying a collector to the liberated target metal particles, wherein the collector modifies the surface properties of the target metal, selectively binding to the surface and imparting hydrophobicitiy to the metal particles; aerating the liberated particles in a flotation cell containing water to produce air bubbles, wherein the particles attach to the particles and float to the surface in the form of a froth, and wherein the waste gangue remains under the surface; and separating the froth from the water so that the target metal can be further refined.

In preferred embodiments, the collector is a biosurfactant according to the subject invention. Advantageously, in certain embodiments, the biosurfactant modifies the surface properties of the target metal, selectively binding to the surface and imparting hydrophobicitiy to the metal to facilitate the attachment of air bubbles. Furthermore, the use of biosurfactants as collectors reduces and/or eliminates the need for conventional collectors, such as, e.g., xanthates (alkyl dithiocarbonates), dithiophosphinates, and thionocarbamates, which are typically petroleum-derived, toxic, hazardous and/or not biodegradable.

### Target Metals and Minerals

Examples of target metals that can be extracted using the methods of the subject invention, as well as ores and/or minerals that produce and/or comprise the target metals, include but are not limited to cobalt (e.g., crythrite, skytterudite, cobaltite, carrollite, linnaeite, and asbolite (asbolane)); copper (e.g., chalcopyrite, chalcocite, bornite, djurleite, malachite, azurite, chrysocolla, cuprite, tenorite, native copper and brochantite); gold (e.g., native gold, electrum, tellurides, calaverite, sylvanite and petzite); silver (e.g., sulfide argentite, sulfide acanthite, native silver, sulfosalts, pyrargyrite, proustite, cerargyrite, tetrahedrites); aluminum (e.g, bauxite, gibbsite, bohmeite, diaspore); antimony (e.g., stibnite); barium (e.g., barite, witherite); cesium (e.g., pollucite); chromium (e.g., chromite); cadmium (e.g., sphalerite, greenockite, hawleyite, ramdohrite); iron (e.g., hematite, magnetite, pyrite, pyrrhotite, goethite, siderite); lead (e.g., galena, cerussite, anglesite); lithium (e.g., pegmatite, spodumene, lepidolite, petalite, amblygonite, lithium carbonate); magnesium (e.g., dolomite, magnesite, brucite, carnallite, olivine); manganese (e.g., hausmannite, pyrolusite, barunite, manganite, rhodochrosite); mercury (e.g., cinnabar); molybdenum (e.g., molybdenitc); nickel (e.g., pentlandite, pyrrhotite, garnicrite); phosphorus (e.g., hydroxylapatite, fluorapatite, chlorapatite); platinum group (platinum, osmium, rhodium, ruthenium, palladium) (e.g., native elements or alloys of platinum group members, sperrylite); potassium (e.g., sylvite, langbeinite); rare earth elements (cerium, dysprosium, erbium, curopium, gadolinium, holmium, lanthanium, lutetium, neodymium, praseodymium, samarium, scandium, terbium, thulium, ytterbium, yttrium) (e.g., bastnasite, monazite, loparite); sodium (e.g., halite, soda ash); strontium (e.g., celestite, strontianite); sulfur (e.g., native sulfur, pyrite); tin (e.g., cassiterite); titanium (e.g., scheelite, huebnerite-ferberite); uranium (e.g., uraninite, pitchblende, coffinite, carnotite, autunite); vanadium; zinc (e.g., sphalerite, zinc sulfide, smithsonite, hemimorphite); and zirconium (e.g., zircon).

Additional elements and/or minerals, the extraction of which the subject invention is useful, include, e.g., arsenic, bertrandite, bismuthinite, borax, colemanite, kernite, ulexite, sphalerite, halite, gallium, germanium, hafnium, indium, iodine, columbite, tantalite-columbite, rubidium, quartz, diamonds, garnets (almandine, pyrope and andradite), corundum, barite, calcite, clays, feldspars (e.g., orthoclase, microcline, albite); gemstones (e.g., diamonds, rubies, sapphires, emeralds, aquamarine, kunzite); gypsum; perlite; sodium carbonate; zeolites; chabazite; clinoptilolite; mordenite; wollastonite; vermiculite; talc; pyrophyllite; graphite; kyanite; andalusite; muscovite; phlogopite; menatite; magnetite; dolomite; ilmenite; wolframite; beryllium; tellurium; bismuth; technetium; potash; rock salt; sodium chloride; sodium sulfate; nahcolite; niobium; tantalum and any combination of such substances or compounds containing such substances.

### Production of Microbe-Based Products

In certain embodiments, the subject invention provides methods for cultivation of microorganisms and production of microbial metabolites and/or other by-products of microbial growth. The subject invention further utilizes cultivation processes that are suitable for cultivation of microorganisms and production of microbial metabolites on a desired scale. These cultivation processes include, but are not limited to, submerged cultivation/fermentation, solid state fermentation (SSF), and modifications, hybrids and/or combinations thereof.

The microorganisms can be, for example, bacteria, yeast and/or fungi. These microorganisms may be natural, or genetically modified microorganisms. For example, the microorganisms may be transformed with specific genes to exhibit specific characteristics. The microorganisms may also be mutants of a desired strain. As used herein, “mutant” means a strain, genetic variant or subtype of a reference microorganism, wherein the mutant has one or more genetic variations (e.g., a point mutation, missense mutation, nonsense mutation, deletion, duplication, frameshift mutation or repeat expansion) as compared to the reference microorganism. Procedures for making mutants are well known in the microbiological art. For example, UV mutagenesis and nitrosoguanidine are used extensively toward this end.

In certain embodiments, the microbes are capable of producing amphiphilic molecules, enzymes, proteins and/or biopolymers. Microbial biosurfactants, in particular, are produced by a variety of microorganisms such as bacteria, fungi, and yeasts, including, for example, Agrobacterium spp. (e.g., A. radiobacter); Arthrobacter spp.; Aspergillus spp.; Aureobasidium spp. (e.g., A. pullulans); Azotobacter (e.g., A. vinelandii, A. chroococcum); Azospirillum spp. (e.g., A. brasiliensis); Bacillus spp. (e.g., B. subtilis, B. subtilis NRRL B-68031, B. amyloliquefaciens, B. amyloliquefaciens NRRL B-67928, B. pumillus, B. cereus, B. licheniformis, B. firmus, B. laterosporus, B. megaterium); Blakeslea; Candida spp. (e.g., C. albicans, C. rugosa, C. tropicalis, C. lipolytica, C. torulopsis); Clostridium (e.g., C. butyricum, C. tyrobutyricum, C. acetobutyricum, and C. beijerinckii); Campylobacter spp.; Cornybacterium spp.; Cryptococcus spp.; Debaryomyces spp. (e.g., D. hansenii); Entomophthora spp.; Flavobacterium spp.; Gordonia spp.; Hansenula spp.; Hanseniaspora spp. (e.g., H. uvarum); Issatchenkia spp; Kluyveromyces spp.; Meyerozyma spp. (e.g., M. guilliermondii); Mortierella spp.; Mycorrhiza spp.; Mycobacterium spp.; Nocardia spp.; Pichia spp. (e.g., P. anomala, P. guilliermondii, P. occidentalis, P. kudriavzevii); Phycomyces spp.; Phythium spp.; Pseudomonas spp. (e.g., P. aeruginosa, P. chlororaphis, P. putida, P. florescens, P. fragi, P. syringae); Pseudozyma spp. (e.g., P. aphidis); Ralslonia spp. (e.g., R. eulropha); Rhodococcus spp. (e.g., R. erythropolis); Rhodospirillum spp. (e.g., R. rubrum); Rhizobium spp.; Rhizopus spp.; Saccharomyces spp. (e.g., S. cerevisiae, S. boulardii sequela, S. torula); Sphingomonas spp. (e.g., S. paucimobilis); Starmerella spp. (e.g., S. bombicola); Thraustochytrium spp.; Torulopsis spp.; Ustilago spp. (e.g., U. maydis); Wickerhamomyces spp. (e.g., W. anomalus, W. anomalus NRRL Y-68030); Williopsis spp.; and/or Zygosaccharomyces spp. (e.g., Z. bailii). In preferred embodiments, microorganism is a Starmerella spp. yeast and/or Candida spp. yeast, e.g., Starmerella (Candida) bombicola, Candida apicola, Candida batistae, Candida floricola, Candida riodocensis, Candida stellate and/or Candida kuoi. In a specific embodiment, the microorganism is Starmerella bombicola, e.g., strain ATCC 22214.

As used herein “fermentation” refers to cultivation or growth of cells under controlled conditions. The growth could be aerobic or anaerobic. In preferred embodiments, the microorganisms are grown using SSF and/or modified versions thereof.

In one embodiment, the subject invention provides materials and methods for the production of biomass (e.g., viable cellular material), extracellular metabolites (e.g., small molecules and excreted proteins), residual nutrients and/or intracellular components (e.g., enzymes and other proteins).

The microbe growth vessel used according to the subject invention can be any fermenter or cultivation reactor for industrial use. In one embodiment, the vessel may have functional controls/sensors or may be connected to functional controls/sensors to measure important factors in the cultivation process, such as pH, oxygen, pressure, temperature, humidity, microbial density and/or metabolite concentration.

In a further embodiment, the vessel may also be able to monitor the growth of microorganisms inside the vessel (e.g., measurement of cell number and growth phases). Alternatively, a daily sample may be taken from the vessel and subjected to enumeration by techniques known in the art, such as dilution plating technique. Dilution plating is a simple technique used to estimate the number of organisms in a sample. The technique can also provide an index by which different environments or treatments can be compared.

In one embodiment, the method includes supplementing the cultivation with a nitrogen source. The nitrogen source can be, for example, potassium nitrate, ammonium nitrate ammonium sulfate, ammonium phosphate, ammonia, urea, and/or ammonium chloride. These nitrogen sources may be used independently or in a combination of two or more.

The method can provide oxygenation to the growing culture. One embodiment utilizes slow motion of air to remove low-oxygen containing air and introduce oxygenated air. In the case of submerged fermentation, the oxygenated air may be ambient air supplemented daily through mechanisms including impellers for mechanical agitation of liquid, and air spargers for supplying bubbles of gas to liquid for dissolution of oxygen into the liquid.

The method can further comprise supplementing the cultivation with a carbon source. The carbon source is typically a carbohydrate, such as glucose, sucrose, lactose, fructose, trehalose, mannose, mannitol, and/or maltose; organic acids such as acetic acid, fumaric acid, citric acid, propionic acid, malic acid, malonic acid, and/or pyruvic acid; alcohols such as ethanol, propanol, butanol, pentanol, hexanol, isobutanol, and/or glycerol; fats and oils such as soybean oil, canola oil, madhuca oil, rice bran oil, olive oil, corn oil, sesame oil, and/or linseed oil; etc. These carbon sources may be used independently or in a combination of two or more.

In one embodiment, growth factors and trace nutrients for microorganisms are included in the medium. This is particularly preferred when growing microbes that are incapable of producing all of the vitamins they require. Inorganic nutrients, including trace elements such as iron, zinc, copper, manganese, molybdenum and/or cobalt may also be included in the medium. Furthermore, sources of vitamins, essential amino acids, and microelements can be included, for example, in the form of flours or meals, such as corn flour, or in the form of extracts, such as yeast extract, potato extract, beef extract, soybean extract, banana peel extract, and the like, or in purified forms. Amino acids such as, for example, those useful for biosynthesis of proteins, can also be included.

In one embodiment, inorganic salts may also be included. Usable inorganic salts can be potassium dihydrogen phosphate, dipotassium hydrogen phosphate, disodium hydrogen phosphate, magnesium sulfate, magnesium chloride, iron sulfate, iron chloride, manganese sulfate, manganese chloride, zinc sulfate, lead chloride, copper sulfate, calcium chloride, sodium chloride, calcium carbonate, and/or sodium carbonate. These inorganic salts may be used independently or in a combination of two or more.

In some embodiments, the method for cultivation may further comprise adding additional acids and/or antimicrobials in the medium before, and/or during the cultivation process. Antimicrobial agents or antibiotics are used for protecting the culture against contamination.

Additionally, antifoaming agents may also be added to prevent the formation and/or accumulation of foam during submerged cultivation.

The pH of the mixture should be suitable for the microorganism of interest. Buffers, and pH regulators, such as carbonates and phosphates, may be used to stabilize plI near a preferred value. When metal ions are present in high concentrations, use of a chelating agent in the medium may be necessary.

The microbes can be grown in planktonic form or as biofilm. In the case of biofilm, the vessel may have within it a substrate upon which the microbes can be grown in a biofilm state. The system may also have, for example, the capacity to apply stimuli (such as shear stress) that encourages and/or improves the biofilm growth characteristics.

In one embodiment, the method for cultivation of microorganisms is carried out at about 5° to about 100° C., preferably, 15 to 60° C., more preferably, 25 to 50° C. In a further embodiment, the cultivation may be carried out continuously at a constant temperature. In another embodiment, the cultivation may be subject to changing temperatures.

In one embodiment, the equipment used in the method and cultivation process is sterile. The cultivation equipment such as the reactor/vessel may be separated from, but connected to, a sterilizing unit, e.g., an autoclave. The cultivation equipment may also have a sterilizing unit that sterilizes in situ before starting the inoculation. Air can be sterilized by methods know in the art. For example, the ambient air can pass through at least one filter before being introduced into the vessel. In other embodiments, the medium may be pasteurized or, optionally, no heat at all added, where the use of low water activity and low pH may be exploited to control undesirable bacterial growth.

In one embodiment, the subject invention further provides a method for producing microbial metabolites such as, for example, biosurfactants, enzymes, proteins, cthanol, lactic acid, beta-glucan, peptides, metabolic intermediates, polyunsaturated fatty acid, and lipids, by cultivating a microbe strain of the subject invention under conditions appropriate for growth and metabolite production; and, optionally, purifying the metabolite. The metabolite content produced by the method can be, for example, at least 20%, 30%, 40%, 50%, 60%, 70%, 80%, or 90%.

The microbial growth by-product produced by microorganisms of interest may be retained in the microorganisms or secreted into the growth medium. The medium may contain compounds that stabilize the activity of microbial growth by-product.

The biomass content of the fermentation medium may be, for example, from 5 g/l to 180 g/l or more, or from 10 g/l to 150 g/l.

The cell concentration may be, for example, at least 1×10⁶ to 1×10¹², 1×10⁷ to 1×10¹¹, 1×10⁸ to 1×10¹⁰, or 1×10⁹ CFU/ml.

The method and equipment for cultivation of microorganisms and production of the microbial by-products can be performed in a batch, a quasi-continuous process, or a continuous process.

In one embodiment, all of the microbial cultivation composition is removed upon the completion of the cultivation (e.g., upon, for example, achieving a desired cell density, or density of a specified metabolite). In this batch procedure, an entirely new batch is initiated upon harvesting of the first batch.

In another embodiment, only a portion of the fermentation product is removed at any one time. In this embodiment, biomass with viable cells, spores, conidia, hyphae and/or mycelia remains in the vessel as an inoculant for a new cultivation batch. The composition that is removed can be a cell-free medium or contain cells, spores, or other reproductive propagules, and/or a combination of thereof. In this manner, a quasi-continuous system is created.

Advantageously, the method does not require complicated equipment or high energy consumption. The microorganisms of interest can be cultivated at small or large scale on site and utilized, even being still-mixed with their media.

In certain embodiments, the subject invention provides a “microbe-based composition,” meaning a composition that comprises components that were produced as the result of the growth of microorganisms or other cell cultures. Thus, the microbe-based composition may comprise the microbes themselves and/or by-products of microbial growth. The microbes may be in a vegetative state, in spore form, in mycelial form, in any other form of propagule, or a mixture of these. The microbes may be planktonic or in a biofilm form, or a mixture of both. The by-products of growth may be, for example, metabolites, cell membrane components, expressed proteins, and/or other cellular components. The microbes may be intact or lysed. The microbes may be present in or removed from the composition. The microbes can be present, with broth in which they were grown, in the microbe-based composition. The cells may be present at, for example, a concentration of at least 1×10³, 1×10⁴, 1×10⁵, 1×10⁶, 1×10⁷, 1×10⁸, 1×10⁹, 1×10¹⁰, 1×10¹¹, 1×10¹², 1×10¹³ or more CFU per milliliter of the composition.

The subject invention further provides “microbe-based products,” which are products that are to be applied in practice to achieve a desired result. The microbe-based product can be simply a microbe-based composition harvested from the microbe cultivation process. Alternatively, the microbe-based product may comprise further ingredients that have been added. These additional ingredients can include, for example, stabilizers, acids, buffers, carriers, such as water, salt solutions, or any other appropriate carrier, added nutrients to support further microbial growth, non-nutrient growth enhancers, and/or agents that facilitate tracking of the microbes and/or the composition in the environment to which it is applied. The microbe-based product may also comprise mixtures of microbe-based compositions. The microbe-based product may also comprise one or more components of a microbe-based composition that have been processed in some way such as, but not limited to, filtering, centrifugation, lysing, drying, purification and the like.

One microbe-based product of the subject invention is simply the fermentation medium containing the microorganisms and/or the microbial metabolites produced by the microorganisms and/or any residual nutrients. The product of fermentation may be used directly without extraction or purification. If desired, extraction and purification can be easily achieved using standard extraction and/or purification methods or techniques described in the literature.

The microorganisms in the microbe-based products may be in an active or inactive form, or in the form of vegetative cells, reproductive spores, conidia, mycelia, hyphae, or any other form of microbial propagule. The microbe-based products may also contain a combination of any of these forms of a microorganism.

In one embodiment, different strains of microbe are grown separately and then mixed together to produce the microbe-based product. The microbes can, optionally, be blended with the medium in which they are grown and dried prior to mixing.

The microbe-based products may be used without further stabilization, preservation, and storage. Advantageously, direct usage of these microbe-based products preserves a high viability of the microorganisms, reduces the possibility of contamination from foreign agents and undesirable microorganisms, and maintains the activity of the by-products of microbial growth.

Upon harvesting the microbe-based composition from the growth vessels, further components can be added as the harvested product is placed into containers or otherwise transported for use. The additives can be, for example, buffers, carriers, other microbe-based compositions produced at the same or different facility, viscosity modifiers, preservatives, nutrients for microbe growth, surfactants, emulsifying agents, lubricants, solubility controlling agents, tracking agents, solvents, biocides, antibiotics, pH adjusting agents, chelators, stabilizers, ultra-violet light resistant agents, other microbes and other suitable additives that are customarily used for such preparations.

Optionally, the product can be stored prior to use. The storage time is preferably short. Thus, the storage time may be less than 60 days, 45 days, 30 days, 20 days, 15 days, 10 days, 7 days, 5 days, 3 days, 2 days, 1 day, or 12 hours. In a preferred embodiment, if live cells are present in the product, the product is stored at a cool temperature such as, for example, less than 20° C., 15° C., 10° C., or 5° C. On the other hand, a biosurfactant composition can typically be stored at ambient temperatures.

### EXAMPLES

It should be understood that the examples and embodiments described herein are for illustrative purposes only and that various modifications or changes in light thereof will be suggested to persons skilled in the art and are to be included within the spirit and purview of this application. In addition, any elements or limitations of any embodiment disclosed herein can be combined with any and/or all other elements or limitations (individually or in any combination) or any other embodiment thereof disclosed herein, and all such combinations are contemplated with the scope of the invention without limitation thereto.

### Example 1

Three surfactant reagents were trialed:
TXS-L-050—a highly purified mixture of SLP molecules containing 90% or more ASL with respect to the total sum of SLP molecules, and 15% or less, non-SLP materials and/or impurities with respect to the volume of the mixture;
TXS-L-051—a mixture of SLP molecules containing 90% or more ASL with respect to the total sum of SLP molecules, and 40% or less non-SLP materials and/or impurities with respect to the total volume of the mixture; and
TXS-L-052—a mixture of SLP molecules containing about 25-30% ASL with respect to the total sum of SLP.

Leaching was performed in a MaxQ 4000 Incubator/Shaker, which is a temperature control unit that both agitates flasks and maintains temperature to a desired set point. Leach conditions are shown below in Table 1. Ferrous/Ferric was the oxidant. The lixiviant was prepared in bulk and all tests were performed concurrently in the Incubator/Shaker to ensure continuity across the tests.

TABLE 1
Phase 1 leach conditions

| Temperature | 60° | C. |
|---|---|---|
| Agitation Solution | 150 | rpm |
| Volume | 400 | mL |
| Solids (wt %) | 5 (10 g) | |
| Lixiviant | Fe³⁺/Fe²⁺ | |
| Lixiviant | 2.5 g/L Fe³⁺, | |
| Concentrations | 2.5 g/L Fe²⁺ 2 | |
| pH | (H₂SO₄) | |
| Leach Duration | 7 | days |

| | |
|---|---|
| Target Solution Potential | 500 mV ± 50 mV |

A total of 4 leaches occurred concurrently in the incubator/shaker, each with an identical lixiviant (prepared in bulk) and each with 10.00g of OREAS 901 Certified Reference Material (CRM) ore standard.

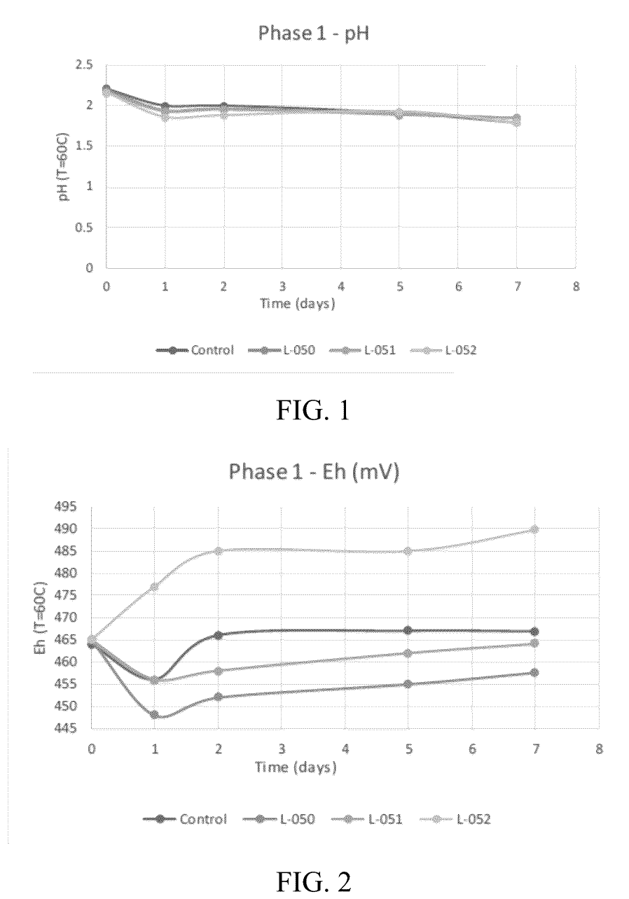

One flask, designated as “Control” flask, had no surfactant reagent added, while the other 3 flasks had the same concentration (1%) of one of the three surfactant reagents mentioned above. Leaching occurred over a 7-day period. Flask weights, solution pH, Eh and temperature were recorded on 4 of the 7 days for monitoring purposes. FIGS. 1-2. Flask weights were roughly used to determine the amount of evaporation, with the lost water content topped up with fresh DI water after pH/Eh readings were taken. Temperature throughout the leach was kept consistent at 60° C.

Feed material was CRM OREAS 901, which is a low-grade copper ore, total copper content of 0.141% with 0.083% being acid-soluble copper. Primary copper sulfide mineralization is Chalcocite (Cu2S) and Chalcopyrite (CuFeS2). Feed assays used for balance purposes were taken from the Ore Datapack as supplied by the vendor; OREAS.CA. Table 2 provides a head assay snapshot of the feed used in the phase I leaching.

TABLE 2
Head assays (OREAS 901 CRM)

| Sample | Cu wt % | Fe wt % | S wt % | Al wt % | Co ppm | Mg wt % | Ni ppm |
|---|---|---|---|---|---|---|---|
| OREAS 901 Feed | 0.141 | 4.03 | 0.04 | 6.81 | 72.98 | 0.60 | 39.88 |

TABLE 3
Copper distribution in feed CRM

| | Total | | Total | Cu-Sol | |
|---|---|---|---|---|---|
| Feed | Cu | Cu-Sol | Cu mass | mass | Cu-Sulfide |
| Sample | (wt %) | (wt %) | (mg) | (mg) | mass (mg) |
| OREAS | 0.141 | 0.083 | 14.096 | 8.304 | 5.792 |
| 901 | | | | | |

After 7 days, the leaches were terminated. The residues and liquors were submitted for assay to complete the mass balance. Solids assays are shown below in Table 4. Less metals were in the residue such as Copper and Cobalt, while Iron and Sulfur were precipitated.

TABLE 4
Copper leaching results, residue and head assays

| Sample | Cu wt % | Fe wt % | S wt % | Al wt % | Co ppm | Mg wt % | Ni ppm |
|---|---|---|---|---|---|---|---|
| OREAS 901 Feed | 0.141 | 4.03 | 0.04 | 6.81 | 73.0 | 0.60 | 39.88 |
| Control Residue | 492 | 8.98 | 1.39 | 5.61 | 27 | 0.49 | 33 |
| TXS-L-050 Residue | 435 | 10.65 | 2.87 | 5.16 | 25 | 0.45 | 29 |
| TXS-L-051 Residue | 414 | 10.82 | 2.98 | 4.99 | 24 | 0.43 | 28 |
| TXS-L-052 Residue | 456 | 8.9 | 1.38 | 5.22 | 26 | 0.44 | 32 |

Mass accountability for the metallurgical balance are shown in Table 5 and Table 6 was generally good for the main elements (Copper, Iron, Cobalt), with slight discrepancies in Aluminum, Sulfur and Magnesium.

TABLE 5
Metallurgical balance mass accountability

| | Mass Balance Accountability | | | | | |
|---|---|---|---|---|---|---|
| Test | Cu | Fe | Al | S | Co | Mg |
| Control | 105% | 99% | 91% | 89% | 94% | 94% |
| TXS-L-050 | 103% | 93% | 87% | 86% | 94% | 92% |
| TXS-L-051 | 100% | 94% | 85% | 91% | 95% | 89% |
| TXS-L-052 | 102% | 95% | 87% | 88% | 91% | 87% |

Overall, copper extraction increased with the addition of the bio-surfactant reagents. Biosurfactant labeled as TXS-L-051 showed the greatest benefit to overall copper extractions versus the control test, followed by TXS-L-050.

TABLE 6
Overall Copper extractions

| | Overall Cu | Δ Overall Ext % |
|---|---|---|
| Test | Extraction | (vs Control) |
| Control | 64% | |
| TXS-L-050 | 67% | +5% |
| TXS-L-051 | 69% | +7% |
| TXS-L-052 | 66% | +3% |

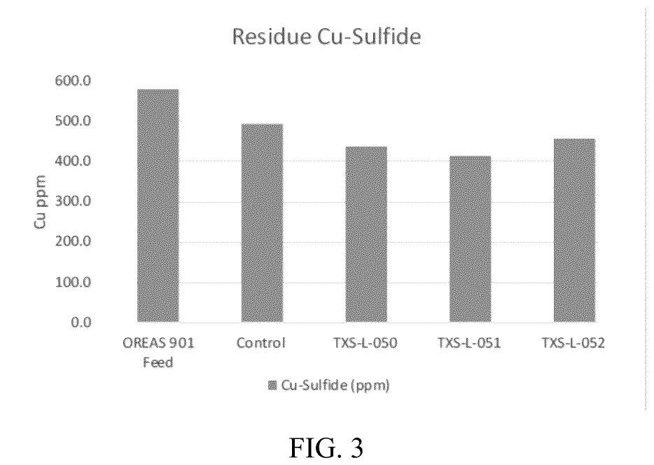

The feed sample contained approximately 59% acid-soluble copper (i.e., Cu-Sol, Table 3). As the leach tests were conducted in acidic conditions (PH ˜2) and the material is supplied with a fine grind size, it can be assumed that 100% of the Cu-Sol is leached within the 7-day leach period and, therefore, the residue is made up of only Copper in sulfide form. The test results show that the biosurfactant reagents increased sulfide leaching by up to 90% when compared against the leach results from the control test, as shown in Table 7 and FIG. 3.

TABLE 7
Copper-sulfide leaching

| | Cu- | | Cu- | Δ Cu- |
|---|---|---|---|---|
| | Sulfide - | Cu- | Sulfide | Sulfide |
| | head | Residue | Ext | Ext % (vs |
| Test | (ppm) | (ppm) | % | Control) |
| Control | 578.9 | 492 | 15% | |
| TXS-L-050 | 578.9 | 435 | 25% | +66% |
| TXS-L-051 | 578.9 | 414 | 28% | +90% |
| TXS-L-052 | 578.9 | 456 | 21% | +41% |

Iron and elemental sulfur precipitation are by-products of leaching copper sulfides in acidic conditions using ferric/ferrous as the oxidant, such as Chalcopyrite and Chalcocite. Both iron and sulfur content of the residues were higher in the tests using the biosurfactant reagents.

TABLE 8
Iron and Sulfur content of the residue

| | Fe-Head | Fe-Residue | Δ Fe % | S-Head | S-Residue | Δ S % |
|---|---|---|---|---|---|---|
| Test | (wt %) | (wt %) | (vs Control) | (wt %) | (wt %) | (vs Control) |
| P1 Control | 4.03 | 8.98 | | 0.04 | 1.39 | |
| P1 TXS-L-050 | 4.03 | 10.65 | +19% | 0.04 | 2.87 | +106% |
| P1 TXS-L-051 | 4.03 | 10.82 | +20% | 0.04 | 2.98 | +114% |
| P1 TXS-L-052 | 4.03 | 8.90 | −+1% | 0.04 | 1.38 | −+1% |

The copper-bearing sulfide minerals in the feed sample were a mixture of Chalcocite and Chalcopyrite of unknown proportions. In general, Chalcopyrite leaching kinetics are slower than Chalcocite due to the more complex nature of the Chalcopyrite mineral structure. Elemental Sulfur and Iron-hydroxysulphate minerals such as Jarosite are known by-products of chalcopyrite leaching and are also considered by many to be the main culprit for passivation of the mineral surface. An increase in the formation of elemental sulfur indicates the breakdown of the sulfide minerals in the sample, therefore showing that the oxidation of copper-sulfide minerals was enhanced in the presence of the biosurfactant reagents.

1. A bioleaching composition comprising an aqueous solution of a biosurfactant and at least one metal solubilizing agent.

2. The bioleaching composition according to claim 1, wherein the biosurfactant is a sophorolipid biosurfactant (SLP).

3. (canceled)

4. The bioleaching composition according to claim 1, comprising at least one metal solubilizing agent selected from acid, and oxidant.

5. The bioleaching composition according to claim 4, comprising at least one acid selected from sulfuric acid, hydrochloric acid, nitric acid, phosphoric acid, and hydrocyanic acid.

6. The bioleaching composition according to claim 4, comprising at least one oxidant selected from ferric chloride, chlorine, bromine, and oxygen.

7. The bioleaching composition according to claim 1, wherein the metal solubilizing agent comprises a microorganism.

8. The bioleaching composition according to claim 7, wherein the microorganism is selected from Acetobacter metanolicus, Acidianus brierleyi, Acidophillum cryptum, Acinomucor sp., Alternaria sp., Artrobacter Sp., Aspergillus amstelodami, Aspergillus clavatus, Aspergillus ficuum, Aspergillus fumigatus, Aspergillus niger, Aspergillus ochraceus, Bacillus sp., Bacillus megaterium, Bacillus polymyxa, Brettanomyces lambicus, Candida sp., Cerostamella sp. Chlorella vulgaris, Chromobacterium violacerum, Cladosprium resinae, Clostridium sp., Coriolus versicolor, Corynebacterium sp., Crenothrix sp., Cunninghamiella sp., Fusarium sp., Gallionella sp., Gleophyllum trabeum, Leptospirilum ferroomidans, Leptospirillum thermoferrooxidans. Leptotrix sp., Metallogenium sp., Metallosphaera sedula, Mucor sp., Paecilomyces variotii, Penicillium brevicompactum, Penicillium cyclopium, Penicillium funiculosum, Penicillium notatum, Penicillium ochrochloron, Penicillium oxalicum, Penicillium simlicissimum, Penicillium spinulosum, Penicillium variotii, Phanerochaete chrusosporium, Pichia sp., Pseudomonas putida, Rhizopus sp., Saccharomyces cerevisiae, Sulfobacillus thermosulfidooxidans, Sulfobacillus thermosulfidooxidans sub. Thermotolerans, Sulfobacillus thermosulfidooxidans sub. Asporogenes, Sulfolobus acidocaldarius, Sulfolobus ambivalens, Sulfolobus solfataricus, Sulfolobus thermosulfidoxidans, Sulfolobus brierlei, Sulfolobus yellowstonii, Sulfurococcus sp., Thermothrix thipara, Thiobacillus sp., Thiobacillus acidophilus, Thiobacillus albertis, Thiobacillus capsulatus, Thiobacillus concretivorus, Thiobacillus caprinus, Thiobacillus delicatus, Thiobacillus denitrificans, Thiobacillus ferrooxidans, Thiobacillus intermedius, Thiobacillus kabobis, Thiobacillus neapolitanus, Thiobacillus novellus, Thiobacillus organoparus, Thiobacillus perometabolis, Thiobacillus prosperous, Thiobacillus rubellus, Thiobacillus tepidarius, Thiobacillus thiocynoxidans, Thiobacillus thiooxidans, Thiobacillusthioparys, Thiobacillus versutus, Trametes versicolor, Trichoderma Harzianum, Tichoderma viride, and Yarrowia lipolytica.

9. A method of bioleaching, comprising:
providing a metal source comprising at least one target metal;
combining the metal source with a bioleaching composition of claim 1 mixing the metal source and bioleaching composition to form a soluble metal-comprising solution and a non-solution phase; and
separating the soluble metal-comprising solution from the non-solution phase.

10. The method according to claim 9, wherein the bioleaching composition comprises a sophorolipid biosurfactant (SLP).

11. (canceled)

12. The method according to claim 9, comprising the use of at least one acid selected from sulfuric acid, hydrochloric acid, nitric acid, phosphoric acid, and hydrocyanic acid.

13. The method according to claim 9, wherein the bioleaching composition further comprises an oxidant selected from ferric chloride, chlorine, bromine, and oxygen.

14. (canceled)

15. The method according to claim 9, wherein the soluble metal-comprising solution comprises the target metal.

16. The method according to claim 15, wherein the target metal is selected from aluminum, arsenic, cerium, cesium, chromium, cobalt, copper, dysprosium, erbium, europium, gadolinium, gallium, germanium, gold, hafnium, holmium, indium, iridium, lanthanum, lead, lithium, lutetium, magnesium, manganese, mercury, neodymium, nickel, niobium, palladium, platinum, praseodymium, rhodium, rubidium, ruthenium, samarium, scandium, silver, tantalum, tellurium, terbium, thallium, tin, titanium, tungsten, uranium, vanadium, vanadium, ytterbium, yttrium, zinc, zirconium, or any mixture thereof.

17. The method according to claim 9, wherein the non-solution phase comprises the target metal.

18. The method according to claim 9, wherein the target metal is selected from gold, silver, platinum, or any mixture thereof.

19-20. (canceled)

21. The method according to claim 9, wherein the metal source is ore, mine tailings, slag, electronic waste, or any combination thereof.

22. The method according to claim 9, wherein the particulate metal source comprises particles of 10 mm or less in diameter.

23. The method according to claim 9, further comprising contacting a pre-leaching composition comprising a biosurfactant with the metal source for a period of time before the metal source is contacted with the bioleaching composition to yield a mixture comprising a treated metal source and an impurity.

24. (canceled)

25. The method according to claim 23, further comprising separating the impurity and the treated metal source from the mixture to obtain a reduced-impurity metal-containing material.

26. The method according to claim 25, wherein the impurity is present in the liquid phase, the reduced-impurity metal-containing material is in a foam that is formed on the surface of the liquid and the foam containing the reduced-impurity metal-containing material is removed from the liquid.

27-38. (canceled)

39. A method of separating a liberated target metal from waste gangue comprising:
providing a liberated target metal in a particulate state comprising waste gangue material;
adding the liberated target metal and gangue to water in the presence of a collector, wherein the collector is a biosurfactant;
supplying aeration to the water, wherein the biosurfactant facilitates the attachment of the target metal to air bubbles supplied by the aeration, wherein the target metal and air bubbles float to the surface of the water in the form of a froth, and wherein the waste gangue remains under the surface of the water; and
collecting the target metal from the froth for refining.

40. The method of claim 39, wherein the biosurfactant is a sophorolipid (SLP).

41. (canceled)
